(19) United States
(12) Patent Application Publication
(10) Pub. No.: US 2004/0218518 A1
(43) Pub. Date: Nov. 4, 2004

(54) Multi-layered data storage card

(75) Inventors: Jeffrey Liu, San Jose, CA (US); Francis K. King, San Jose, CA (US)

Correspondence Address: Bo-In Lin, 13445 Mandoli Drive, Los Altos Hills, CA, 94022, US

(73) Assignee: DCARD, INC.

(21) Appl. No.: 10/862,966

(22) Filed: Jun. 7, 2004

Related U.S. Application Data
(63) Continuation-in-part of application No. 10/779,961, filed on Feb. 17, 2004.
Application No. 10/779,961 is a continuation-in-part of application No. 10/424,341, filed on Apr. 28, 2003.
(60) Provisional application No. 60/419,293, filed on Oct. 16, 2002.

(51) Int. Cl. G11B 7/00

(52) U.S. Cl. 369/292; 369/94

(57) ABSTRACT

A multiple layer data storage card for storage of machine-readable information includes an optical memory area subjected to optical information recording and reproduction, comprising, a card-like card body, an optical recording portion provided on said card body, and optionally a conventional magnetic data stripe area, and a smart card IC area. The optical memory area including an optionally pre-recorded data area and a recordable area all with pre-grooved track segment arrangement for logical data recording and retrieving.

This Application is a Continuation-in-Part Application (CIP) of a previously filed Ser. No. 10/779,961 filed on Feb. 17, 2004. Application Ser. No. 10/779,961 is a CIP of application Ser. No. 10/424,341 filed on Apr. 28, 2003, and the application Ser. No. 10/424,341 is a continuation-in-Part (CIP) Application of a Provisional Application 60/419,293 filed on Oct. 16, 2002.

### BACKGROUND OF THE INVENTION

1. Field of the Invention

This invention relates generally to systems and method for reading data from and writing data to data storage medium by employing the magnetic and optical recording technologies. More particularly, this invention is related to an improve method for manufacturing a data card with an optical data-recoding zone that includes a recording layer having a plurality of segmented data tracks preferably arc-shaped data track segments where the recording layer is an original and integrated layer of the data card.

2. Description of the Prior Art

Over the years, conventional techniques of accessing data stored on data storage media, particularly on data cards provided with magnetic strip or “Smart Card”, are limited by the amount of data that can be stored in such storage media. Furthermore, the conventional techniques for providing data strips for storing personal data are further limited by the difficulties that the magnetic strip is often damaged by scratched surface and the optical strip if not formed on the back of a plastic card to extend over the entire length over the whole surface of the card often become peeled off due to a lack of sufficient bonding strength to the card. Such difficulties cause problem of reliability in using the card for ID or security verification and authentication by storing data on the back of the credit card or ID card.

The technologies of accessing data stored in data storage media commonly available are limited to either reading/writing data on a data strips, e.g., magnetic data strip(s) on the back of a credit card or identification card, on circular data tracks, e.g., a flopping diskette, or data stored in semiconductor chips, e.g., Smart-card chip. Limited by these data storage configurations, the amount of data that can be stored in the credit cards are quite limited. For the purpose of preventing credit card fraud or identification theft, it is often necessary to provide card owner's biometrics data on the cards such as the thumbprints, DNA, iris or picture of the true card owner. However, some of the Smart-card chips and magnetic strips as now commonly utilized in a credit card store sampled thumbprints (not a true copy) yet still do not have sufficient capacity to store pictures and more detailed biometrics data. Furthermore, the conventional credit card readers when reading the magnetic strips generally do not have the capabilities to process the data to display the picture in order to identify the true owner of a credit card. For these reasons, despite the advancements now made in the technologies of data storage and data processing, the effectiveness of preventing identification thefts and credit card frauds is still limited by these technical difficulties. Even that the “Smart Card” chip implemented as semiconductor storage chip added to the credit cards or identification cards for the purpose of storing more data but such “Smart Card” chips are much more expensive than the magnetic strips as now commonly implemented and the Smart-card chips still do not provide sufficient storage capacities for effective fault prevention.

Drexler disclosed in several patented inventions different data storage media to overcome these limitations. In U.S. Pat. No. 4,609,812 entitled “Prerecorded strip data storage card”, Drexler discloses a data storage card with spaced apart data strips. The card is wallet-size and preferably the strips run parallel to the lengthwise dimension of the card. One strip is made of a high capacity reflective read-only optical memory (ROM) material. The other strip is a magnetic recording material. The high capacity ROM strip may be made of a laser-recorded material or it may be made of a material that is prerecorded using a photographic process. The two strips store complementary data in database applications.

In U.S. Pat. No. 4,680,460 entitled “System and method for making recordable wallet-size optical card”, Drexler discloses a system and method for making a data card involving prerecording information, such as reference position information or servo tracks, on a strip of high resolution, immediate read laser recording material, then adhering the strip to a card such that the strip is recordable in place. A protective transparent laminating material is bonded to the recording surface and then user information is recorded on the strip using a laser aimed at the strip through the laminating material.

In U.S. Pat. No. 4,692,394, entitled “Method of Forming a Personal Information Card”, Drexler discloses a personal information is recorded on an information medium containing both visual images, such as a face image or fingerprint, and laser recorded data. The visual images are created on a piece of photographic material or eye readable laser recording material. The visual image material is adhered to a surface of a wallet-size card. A strip of laser recordable optical data storage material is also adhered to the card. After the strip is put on the card, a laser records personal information indicia on the strip in situ. The strip may be a reflective material of silver particles in a gelatin matrix, in which recording produces spots having a detectable difference in reflectivity. The card may be coated with a transparent protective laminate material.

In additional patents, e.g., U.S. Pat. Nos. 6,199,761, 4,863,819, 4,542,288, 4,810,868 disclosed further designs and configurations for storing data on data cards. However, these data cards are still limited by the optical recording technology capacities and the complex process to form the data strips to the data cards.

In U.S. Pat. No. 5,982,736 Pierson disclosed “Trading card optical compact disc and methods of using and forming same provides a trading card” using readily optical compact disc and methods which are compatible with existing disc readers and relatively inexpensive to manufacture. Such method is mainly for mass volume trading card type application and is not suitable for credit card and security identification purpose.

The Applicants of this Application had submitted prior patent application Ser. No. 10/779,961 and disclosed inventions related to the data read/write systems and data storage medium. The Applicants further disclosed in previous patent applications now issued into U.S. Pat. Nos. 6,502,755 and 6,311,893. The disclosures made in the application Ser. No. 10/779,961 and those patents are hereby incorporated by Reference in this Patent Application.

Another technical difficulty is the thickness standard as that required for a typical credit card or identification cards provided with magnetic strips or Smart card chip. In order to be compatible with such thickness standards, any data storage tracks for storing additional data using a standard credit card or identification card must comply with such thickness standards. Compatibility with the thickness standards is mandatory such that the added data tracks can be conveniently implemented without affecting the operation of the magnetic strips or Smart card chip with existing platforms implemented with magnetic strip card or Smart card readers available in almost every store connected to the networks and databases to perform identification and credit checks.

Therefore, a need still exists to provide an improved data access device and data-card storage configuration that is compatible with the credit card thickness standard to process and store data in such that more data can be available for card user authentication applications to overcome the above-mentioned difficulties and limitations.

### SUMMARY OF THE PRESENT INVENTION

It is an object of the present invention to provide a rectangular integrated optical card and manufacturing methods which are readily compatible with existing optical compact disc (CD) technology and relatively inexpensive to manufacture. A data card complying with the size of standard of credit cards to store data both in a magnetic strip and/or semiconductor chip such as Smart-card chip and also in this optical data storage area. The magnetic data strips may be identical to a conventional magnetic strip stored data now commonly processed by the remote data processing center as now implemented in the credit card or ID card industries. Additional data such as user's biometrics data, or other information could be stored in the optically accessible data area. These additional data may be processed locally by employing a card reader as described in U.S. Pat. No. 6,311,893 or an enhanced and modified Compact Disk (CD) reader or DVD reader.

Specifically, this invention discloses a recording media operated with data track configuration by employing a magnetic stripe and a group of a plurality of data arc segments or circular data tracks and optionally a semiconductor memory chip such as a Smart-card chip. The magnetic data stripe are compatible and operable with conventional credit card or ID card readers while the data arc segments or circular data tracks contain additional authentication information for identifying a true owner of a credit card or ID card to prevent credit card fraud or identification theft. Specific processing steps and layer structure are provided to manufacture the data arc segments of circular data tracks such that the size of the data card is compatible with the size standard of the credit cards.

Briefly, in a preferred embodiment, the present invention discloses a multiple layers data storage card that includes at least an optical data track area for storing data accessible with an optical data accessing means. The multiple layers data storage card further has at least a magnetic stripe for storing data accessible with a magnetic data accessing means and optionally a semiconductor chip for storing data accessible with a semiconductor data accessing means. The optical data tracks may have different configurations such as a plurality of circular arc segments, a plurality of arc segments formed as spiral segments having a fixed center rotating with continuously varying radius. The optical data track may be a plurality of arc segments formed as spiral segments having a moving center rotating with continuously varying radius. The optical data track may be a plurality of arc segments formed as circle segments having a fixed center of concentric circles. The optical data track may be a plurality of arc segments formed as circle segments having a moving center rotating with a constant radius. The optical data track may be two arc segments of different lengths. The optical data track may be a circular, spiral arc segment, or a linear data-track segment. The optical memory area further includes a protective layer as a bottom layer. The protective layer has a trench for disposing a recording layer therein. Alternately, the additional layers, e.g., a reflective layer, a dye layer, a dielectric layer, a metal phase-change (PC) layer, etc., may be formed in the trench of the protective layer. A focusing layer is formed on top of the protective layer to cover and seal the recording layer and other layers in the trench. Such configuration insure that the recording layer would not peel off and greatly improve the reliability of the data stored in the data tracks disposed on the recording layer. The tracks in the optical memory area can have pre-groove and wobbling signal arrangement that are compatible with available optical disc technology such as CDR, CDRW, DVDR, and DVDRW. The data card can have optional registration hole or mark, index holes or marks, and write protect hold or mark to interface card readers. The method of making such card can be from a readily available optical disc process.

The optical memory area of the data card can have pre-recorded data, a laser head power calibration area, a system partition area, a defect management area, and a user data area. The starting point of sectors at each track from track to track can be aligned or not aligned to each other.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 shows a data card with optical data storage area, magnetic stripe area, and Smart IC area. FIG. 1A shows a paper strip or a specially coated strip on the card to allow for a cardholder to sign.

FIG. 2 shows a data card with a registration hole compatible with an optical compact or DVD disc.

FIG. 3 shows a data card with optical data storage area and ISO 7811 compatible magnetic stripe area, and Smart IC area.

FIGS. 4, 4A, 4B, 4C show the construction layers of optical data storage area that can be CDROM, CDRW, DVD, DVDR, DVDRW compatible.

FIG. 5 shows the optional optical track start, track end, and write protect holes.

FIG. 6 shows the pre-groove and wobbling signal arrangement of optical tracks. The arrangement can be compatible with CDR, CDRW, DVDR and DVDRW format standards.

FIG. 7 shows possible region of pre-recorded data, such as manufacturing identification, an optical head power calibration area, a system partition area, a defect management area, and a user data area. The prerecorded data can be in the optical pits such as CDROM type structure or pre-groove wobbling forms such as CDR type of structure.

FIG. 8 shows the spiral arrangement of tracks in optical data storage area.

FIG. 9 shows the concentric arrangement of tracks in optical data storage area.

FIG. 10 shows the non-aligned starting sector of a track from track to track in optical data storage area.

FIG. 11 shows the starting sector of a track aligned from track to track in optical memory area.

FIG. 12 shows the data card is made from a disc shape mold.

### DETAILED DESCRIPTION OF THE PREFERRED EMBODIMENT

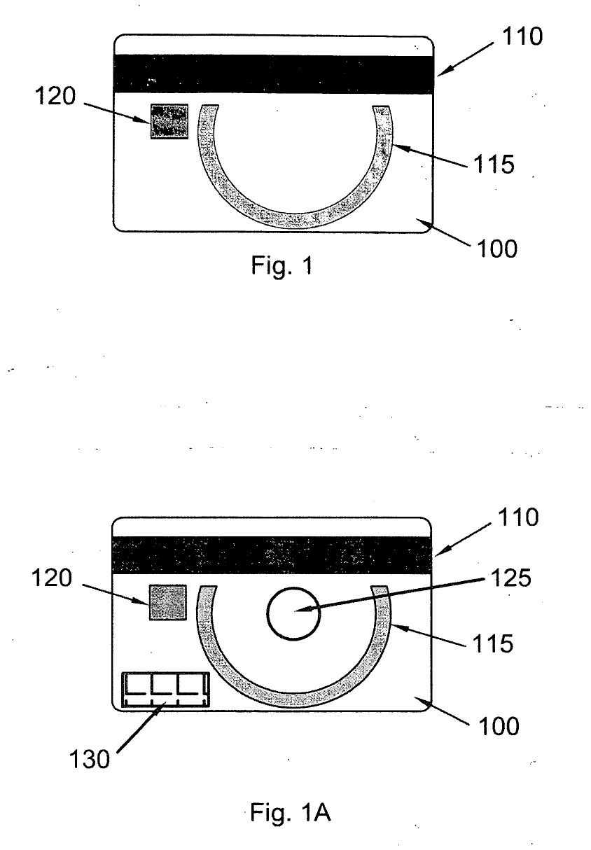

FIG. 1 shows a data card 100 that has substantially a same size as a standard credit card or identification card, e.g. a Driver's License, which can be conveniently carried in a standard wallet. Preferably, the data card 100 is formed on an optical disk suitable for making regular optical compact disk (CD). Just like a regular credit card or Driver's License, the data card 100 has a magnetic strip 110 to store credit card or ID information that can be conveniently readout and transmitted by current credit card or debit card verification readers available in many stores, ATM machines, Gas stations, Banks, Membership Club or Driver's License reader carried by a police driving a highway patrol car. The data card includes a curve-shaped optical data-recording zone 115 that includes a plurality of optical data recording tracks. The data card further includes a Smart-card chip 120. As shown in FIG. 1A, the data card 100 may include a paper strip or a specially coated strip 130 just like a regular credit card to allow for a user to sign on the paper strip.

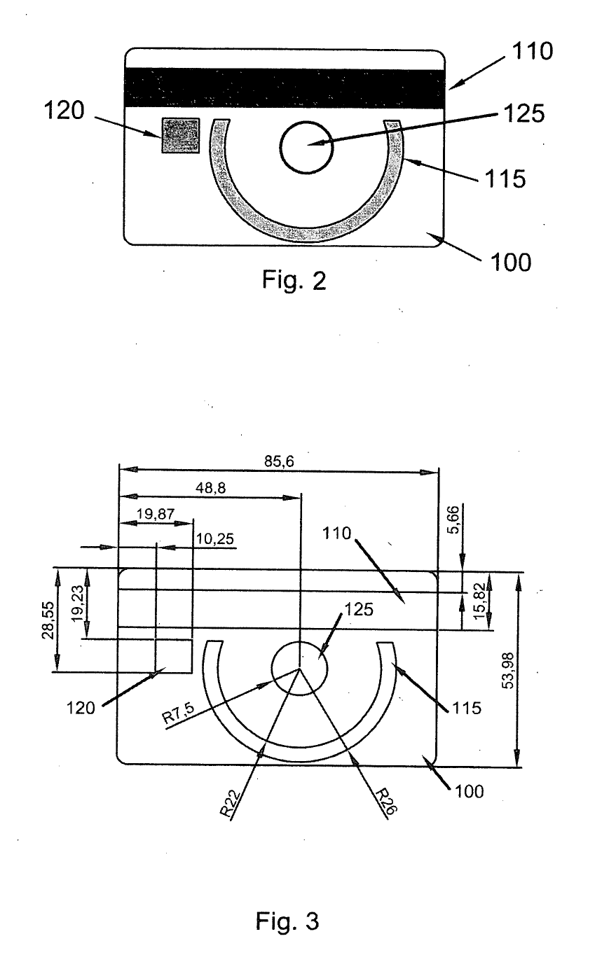

FIG. 2 shows a similar card as that of FIG. 1 that further has a hole 125 in the center just like a regular optical CD. FIG. 3 shows a preferred embodiment with detail dimensions of the memory card wherein the curve-shaped optical data-recording zone 115 and the hole 125 are formed and is ISO 7811 compatible with the magnetic stripe area, and the Smart IC Card area.

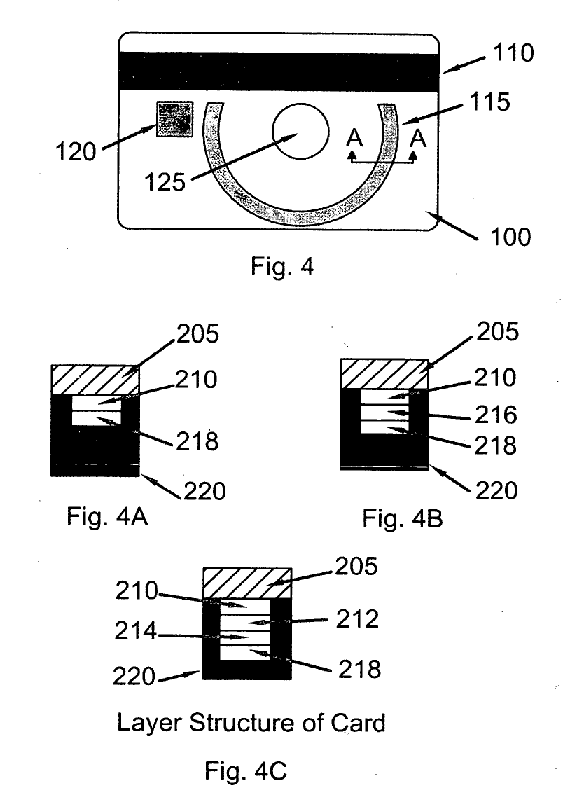

FIGS. 4 and 4A to 4C are respectively top view and three cross sectional views to show the layer structure of the curve-shaped optical data recording zone 115. Referring to FIGS. 4A to FIG. 4C for three different layer structures across line A-A′ shown in FIG. 4. These layer structures are provided to be compatible with CDR, CDRW, DVDR and DVDRW format standards. Referring to FIG. 4A, a top layer 205 is a focusing layer composed of a substrate material that can be glass, polycarbonate or other laser beam transparent materials to project a laser beam there through for accessing data stored in a recording layer 210. Underneath the focusing layer are a recording layer 210 and a reflective layer 218 supported on a protective layer 220 made of lacquer type of materials. The recoding layer 210 is composed of laser sensitive material for storing data therein.

FIG. 4B shows a layer structure of a CDR or DVDR recording zone with the recording layer 210 covered by a focus layer 205 on the top and supported by a dye layer 216 and a reflective layer 218. The recording layer 210, the dye layer 216 and the reflective layer 218 have a smaller area than the protective layer 220 and are surrounded by the protective layer 220. FIG. 4C shows a layer structure of a CDRW or DVDRW recording zone with the recording layer 210 covered by a focus layer 205 on the top and supported by a dielectric layer 212, a metal phase change layer 214 and a reflective layer 218. The recording layer 210, the dielectric layer 212, the metal phase change layer 214 and the reflective layer 218 have a smaller area than the protective layer 220 and are surrounded by the protective layer 220.

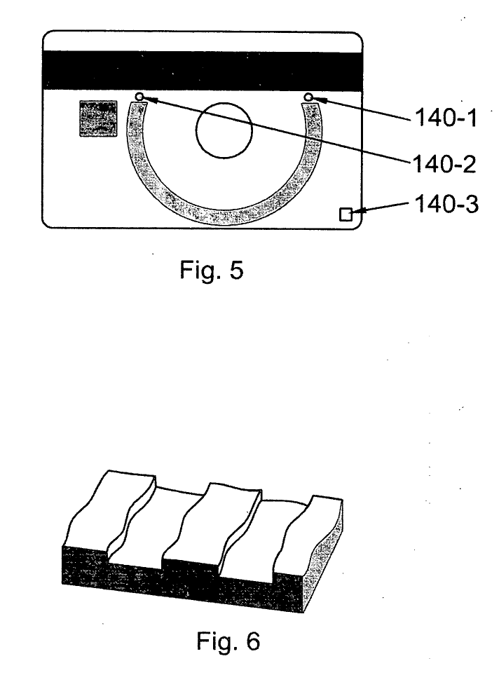

Referring to FIG. 5 for an alternate preferred embodiment, wherein the data card further has track starting index hole 140-1 and/or track ending index hole 140-2. Those pre punched holes to set on/off functions for Optical pickup focusing, reading writing and track seeking. The write protection holes 140-3 are provided to allow write function of Optical pickup. For instance, it is allowed for writing data onto the data tracks when the hole is open. Writing of data to the data tracks are prohibited when the hole is blocked.

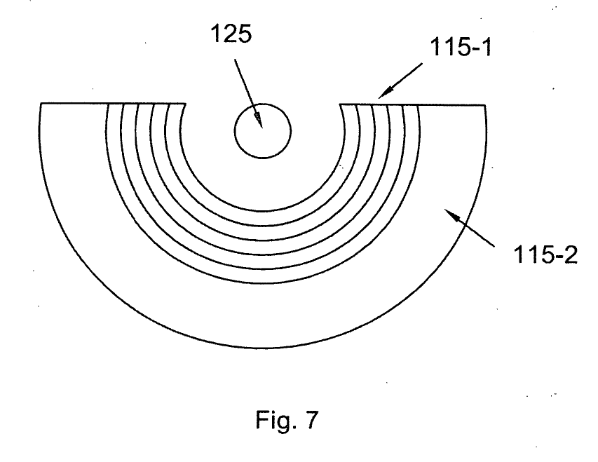

FIG. 6 shows the pre-groove and wobbling data signal arrangement of optical tracks. The arrangement can be compatible with CDR, CDRW, DVDR and DVDRW format standards. Those signals provide servo control of track following and addressing.

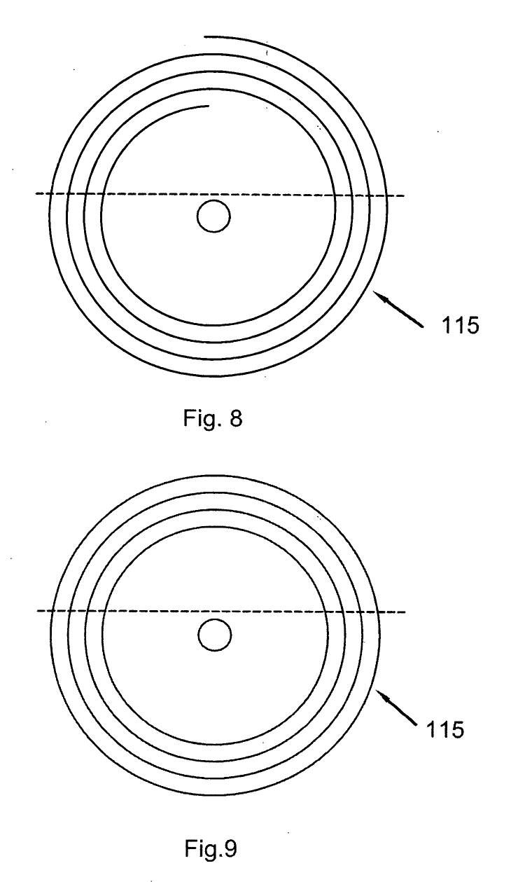

FIG. 7 shows possible region of pre-recorded data tracks 115-1, such as manufacturing identification, a Optical pickup power calibration area, a system partition area, a defect management area, and a user data area 115-2. The prerecorded data can be in the optical pits or pre-groove wobbling forms. The data tracks in the optical data-recording zone can be configured as spiral arcs as shown in FIG. 8 or as concentric circles as that shown in FIG. 9.

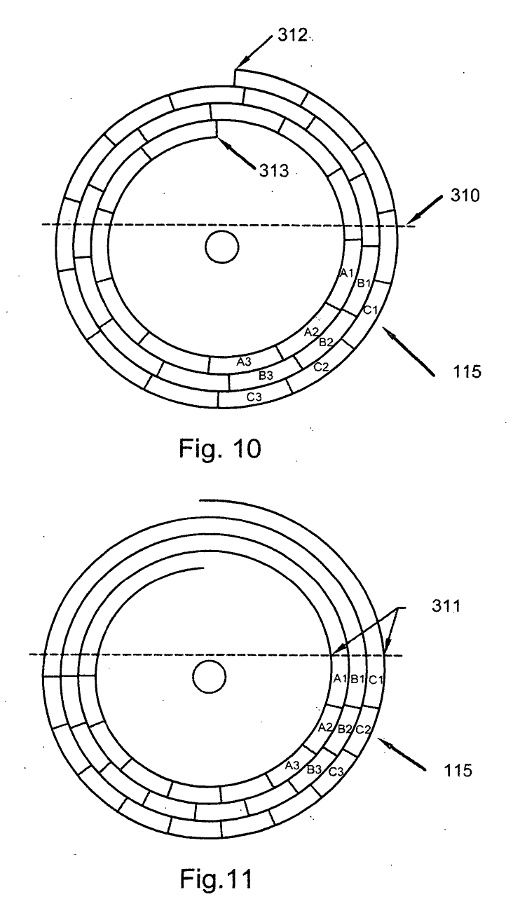

A data arc track is generally divided into a plurality of data sectors (blocks). FIG. 10 show all first data sectors A!, B1, C1 . . . etc. on each data arc tracks are not aligned from line 310. Those non-aligned sectors are formed from either beginning or ending of the spiral line 312 or 313. FIG. 11 show the data sectors (blocks) A1, B1, C1 of each data arc tracks are aligned from line 311 for simpler and more convenient servo control and address in reading and writing the data to each of these data sector in each of the data arc tracks.

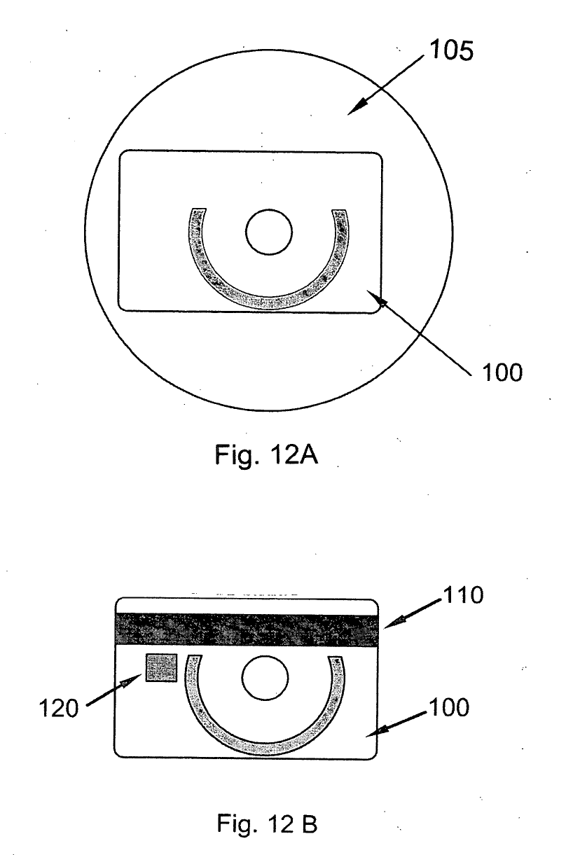

FIG. 12 shows the data card 100 is made from an optical disc 105 Such as CD, CDR, CDRW, DVD, DVDR and DVDRW . . . etc. The manufacturing process begins by form a curve-shaped data-recording zone 115 on the optical disk 105 as that shown in FIG. 12A. Then the optical disk 105 is scribed to the data card 100 as that shown in FIG. 12B. Additional processes are carried out to place the magnetic data strip 110 and the Smart-card Chip 120 onto the data card 100.

According to above drawings and discussion, this invention discloses a method to form an optical data storage card. The method includes a step of forming at least a segmented optical data track in a disk as an integrated layer for storing data accessible with an optical pickup head. In a preferred embodiment, the step of forming the optical data-track further including a step of forming a plurality of circular arc segments. In a preferred embodiment, the step of forming the optical data track further including a step of forming a plurality of arc segments as spiral segments having a fixed center rotating with continuously varying radius. In a preferred embodiment, the step of forming the optical data track further including a step of forming a plurality of arc segments formed as spiral segments having a moving center rotating with continuously varying radius. In a preferred embodiment, the step of forming the optical data track further including a step of forming at least two arc segments of different lengths. In a preferred embodiment, the step of forming the optical data track further including a step of forming a circular arc segment. In a preferred embodiment, the step of forming the optical data track further including a step of forming a spiral arc segment. In a preferred embodiment, the step of forming the optical data track further including a step of forming a linear data-track segment. In a preferred embodiment, the step of forming the segmented optical data track in a disk as an integrated layer is a step of forming the segmented optical data track in a data-recording disk as an integrated layer. In a preferred embodiment, the step of forming the segmented optical data track in a disk as an integrated layer is a step of forming the segmented optical data track in an a data-recording disk as an integrated layer. In a preferred embodiment, the step of forming the segmented optical data track in a disk as an integrated layer is a step of forming the segmented optical data track in a regular circular data recording disk as an integrated layer followed by cutting off a rectangular card therefrom to form the data storage card. In a preferred embodiment, the step of forming the optical data track further including a step of opening a trench in the disk for disposing a recording layer therein for containing the optical data track.

This invention also discloses a data-storage card that includes at least an optical data track for storing data accessible with an optical pickup head wherein the optical data track disposed on an integrated layer formed by processing a disc to form said the storage card. In a preferred embodiment, the optical data track disposed on a recording layer as part of the integrated layer formed by processing an optical disc to form the data storage card. In a preferred embodiment, the integrated layer including the optical data track is disposed in a trench opened in the disk.

This invention further discloses a data-storage card that includes at least a write protective hole in the card for preventing changes to a data recorded on the optical data track. In a preferred embodiment, the data-storage card further includes a central hole as provided in a typical data-recording disk. In a preferred embodiment, the integrated layer includes the optical data track formed with a lower surface profile than the data-storage card. In a preferred embodiment, the disk for processing to form the data storage card is a data-recording disk. In a preferred embodiment, the disk for forming the data storage card is an optical data-recording disk. In a preferred embodiment, the data storage card is a cutoff rectangular card cut off from a circular disk useful for forming a standard data-recording disk. In a preferred embodiment, the data-storage card further includes at least a track starting index hole pre-punched on the data-storage card for setting on function for an optical pickup head to focus, read, write, track seeking and address-following. In a preferred embodiment, the data-storage card further includes at least one track ending index hole pre-punched on the data-storage card for setting off the optical pickup head from focusing, reading, writing, track seeking and address-following. In a preferred embodiment, the optical track on the data-storage card further includes pre-groove and wobbling data signal arrangement for storing servo and data information. In a preferred embodiment, the optical track further includes at least one region of pre-recorded data track for includes data of a manufacturing identification, an optical pickup head power calibration area, a system partition area, a defect management area, and a user data area. In a preferred embodiment, the region of pre-recorded data track further includes pre-recorded data of in optical pits like CDROM structure or in pre-groove and wobbling signal like CDR structure. In a preferred embodiment, the optical data track further divided into at least one data sector having a sector beginning point aligned with a beginning point of the data track. In a preferred embodiment, the data-storage card further includes a plurality of optical data tracks each having at least a mutually aligned data sector with another of the data sector disposed on a neighboring data track. In a preferred embodiment, the data-storage card further includes a plurality of optical data tracks each having at least a mutually misaligned data sector with another of said data sector disposed on a neighboring data track.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A data-storage card comprising:
at least an optical data track for storing data accessible with an optical pickup head wherein said optical data track disposed on an integrated layer formed by processing a disc to form said data storage card.

2. The data-storage card of claim 1 further comprising:
at least a magnetic data track for storing data accessible with a magnetic data accessing means.

3. The data-storage card of claim 1 further comprising:
a semiconductor chip for storing data accessible with a semiconductor data accessing means.

4. The data-storage card of claim 1 wherein:
said optical data track further having a plurality of circular arc segments.

5. The data-storage card of claim 1 wherein:
said optical data track further having a plurality of arc segments formed as spiral segments having a fixed center rotating with continuously varying radius.

6. The data-storage card of claim 1 wherein:
said optical data track further having a plurality of arc segments formed as spiral segments having a moving center rotating with continuously varying radius.

7. The data-storage card of claim 1 wherein:
said optical data track further having a plurality of arc segments formed as circle segments having a fixed center of concentric circles.

8. The data-storage card of claim 1 wherein:
said optical data track further having a plurality of arc segments formed as circle segments having a moving center rotating with constant radius.

9. The data-storage card of claim 1 wherein:
said optical data track further having at least two arc segments of different lengths.

10. The data-storage card of claim 1 wherein:
said optical data track further having a circular arc segment.

11. The data-storage card of claim 1 wherein:
said optical data track further having a spiral arc segment.

12. The data-storage card of claim 1 wherein:
said optical data track further includes a linear data-track segment.

13. The data-storage card of claim 1 wherein:
said optical data track disposed on a recording layer as part of said integrated layer formed by processing an optical disc to form said data storage card.

14. The data-storage card of claim 1 wherein:
said integrated layer including said optical data track is disposed in a trench opened in said disk.

15. The data-storage card of claim 1 wherein:
said integrated layer including said optical data track disposed on a recording layer is disposed in a trench opened in said disk and said integrated layer further having a reflective layer disposed below said recording layer in said trench.

16. The data-storage card of claim 15 wherein:
said integrated layer for disposing said data track further having a dye layer disposed in said trench below said recording layer.

17. The data-storage card of claim 15 wherein:
said integrated layer for disposing said data track further having a dielectric layer disposed in said trench.

18. The data-storage card of claim 15 wherein:
said integrated layer for disposing said data track further having a metal phase-change (PC) layer disposed in said trench.

19. The data-storage card of claim 1 wherein:
said integrated layer including said optical data track is disposed in a trench opened in said disk; and
said integrated layer further includes a focusing layer overlying said disk and sealing said recording layer in said trench.

20. The data-storage card of claim 15 wherein:
said integrated layer further includes a focusing layer overlying said disk and sealing said recording layer and said reflective layer in said trench.

21. The data-storage card of claim 16 wherein:
said integrated layer further includes a focusing layer overlying said disk and sealing said recording layer, said dye layer and said reflective layer in said trench.

22. The data-storage card of claim 17 wherein:
said integrated layer further includes a focusing layer overlying said disk and sealing said recording layer, said reflective layer and said dielectric layer in said trench.

23. The data-storage card of claim 18 wherein:
said integrated layer further includes a focusing layer overlying said disk and sealing said recording layer, said reflective layer and said metal phase-change (PC) layer in said trench.

24. The data-storage card of claim 1 further comprising:
at least a write protective hole in said card for preventing changes to a data recorded on said optical data track.

25. The data-storage card of claim 1 further comprising:
a central hole as provided in a typical data-recording disk.

26. The data-storage card of claim 1 wherein:
said integrated layer includes said optical data track formed with a lower surface profile than said data-storage card.

27. The data-storage card of claim 1 wherein:
said disk for processing to form said data storage card is a data-recording disk.

28. The data-storage card of claim 26 wherein:
said disk for forming said data storage card is an optical data-recording disk.

29. The data-storage card of claim 28 wherein:
said data storage card is a cutoff rectangular card cut off from a circular disk useful for forming a standard data recording disk.

30. The data-storage card of claim 1 further comprising:
at least a track starting index hole pre-punched on said data-storage card for setting on function for an optical pickup head to focus, read, write, track seeking and address-following.

31. The data-storage card of claim 30 further comprising:
at least one track ending index hole pre-punched on said data-storage card for setting off said optical pickup head from focusing, reading, writing, track seeking and address-following.

32. The data-storage card of claim 1 wherein:
said optical track on said data-storage card further including pre-groove and wobbling data signal arrangement for storing servo and data information.

34. The data-storage card of claim 1 wherein:
said optical track further includes at least one region of pre-recorded data track for including data of a manufacturing identification, an optical pickup head power calibration area, a system partition area, a defect management area, and a user data area.

35. The data-storage card of claim 34 wherein:
said region of pre-recorded data track further including pre-recorded data of in optical pits like CDROM structure or in pre-groove and wobbling signal like CDR structure.

36. The data-storage card of claim 1 wherein:
said optical data track further divided into at least one data sector having a beginning point of a first sector aligned with a beginning point of said data track.

37. The data-storage card of claim 1 wherein:
said data-storage card further including a plurality of optical data tracks each having a first sector wherein a beginning point for each of said first sectors are mutually aligned with another and also aligned with a beginning point of said data track.

38. The data-storage card of claim 1 wherein:
said data-storage card further including a plurality of optical data tracks each having a first sector wherein a beginning point of each of said first sectors are misaligned from one another and misaligned from a beginning point of said data track.

39. The data-storage card of claim 1 further comprising:
a central hole having a diameter about 7.5 millimeters as provided in a typical data-recording disk.

40. The data-storage card of claim 28 wherein:
said data storage card is a cutoff rectangular card cut off from a circular disk useful for forming a standard data recording disk having a length of about 85.6 millimeters and a width of about 54 millimeters.

41. A method to form an optical data storage card comprising:
forming at least a segmented optical data track in a disk as an integrated layer for storing data accessible with an optical pickup head.

42. The method of claim 41 wherein:
said step of forming said optical data track further including a step of forming a plurality of circular arc segments.

43. The method of claim 41 wherein:
said step of forming said optical data track further including a step of forming a plurality of arc segments as spiral segments having a fixed center rotating with continuously varying radius.

44. The method of claim 41 wherein:
said step of forming said optical data track further including a step of forming a plurality of arc segments formed as spiral segments having a moving center rotating with continuously varying radius.

45. The method of claim 41 wherein:
said step of forming said optical data track further including a step of forming at least two arc segments of different lengths.

46. The method of claim 41 wherein:
said step of forming said optical data track further including a step of forming a circular arc segment.

47. The method of claim 41 wherein:
said step of forming said optical data track further including a step of forming a spiral arc segment.

48. The method of claim 41 wherein:
said step of forming said optical data track further including a step of forming a linear data-track segment.

49. The method of claim 41 wherein:
said step of forming said segmented optical data track in a disk as an integrated layer is a step of forming said segmented optical data track in a data recording disk as an integrated layer.

50. The method of claim 41 wherein:
said step of forming said segmented optical data track in a disk as an integrated layer is a step of forming said segmented optical data track in an optical data recording disk as an integrated layer.

51. The method of claim 41 wherein:
said step of forming said segmented optical data track in a disk as an integrated layer is a step of forming said segmented optical data track in a regular circular data recording disk as an integrated layer followed by cutting off a rectangular card therefrom to form said data storage card.

52. The method of claim 41 wherein:
said step of forming said optical data track further including a step of opening a trench in said disk for disposing a recording layer therein for containing said optical data track.

53. The method of claim 41 wherein:
said step of forming said optical data track further including a step of opening a trench in said disk for disposing a recording layer therein for containing said optical data track and disposing a reflective layer below said recording layer in said trench.

54. The method of claim 41 wherein:
said step of forming said optical data track further including a step of opening a trench in said disk for disposing said recording layer therein for containing said optical data track and disposing a dye layer in said trench below said recording layer.

55. The method of claim 41 wherein:
said step of forming said optical data track further including a step of opening a trench in said disk for disposing said recording layer therein for containing said optical data track and disposing a dielectric layer in said trench.

56. The method of claim 41 wherein:
said step of forming said optical data track further including a step of opening a trench in said disk for disposing said recording layer therein for containing said optical data track and disposing a metal phase-change (PC) layer in said trench.

57. The method of claim 41 wherein:
said step of forming said optical data track further including a step of opening a trench in said disk for disposing said recording layer therein for containing said optical data track and disposing a focusing layer for covering said trench and sealing said recording layer in said trench.

58. The method of claim 41 further comprising:
disposing a write protecting hole on said data storage card for preventing changes made to data recording in said segmented data tracks.

59. The method of claim 41 further comprising:
disposing at least a magnetic data track for storing data accessible with a magnetic data accessing means.

60. The method of claim 41 further comprising:
disposing a semiconductor chip for storing data accessible with a semiconductor data accessing means.
